(19) United States
(12) Patent Application Publication
(10) Pub. No.: US 2005/0016151 A1
(43) Pub. Date: Jan. 27, 2005

(54) Hold down clip for a reciprocating cutter bar

(75) Inventor: David Ray Lolley, Bettendorf, IA (US)

Correspondence Address: Kevin J. Moriarty;Patent Department, DEERE & COMPANY, One John Deere Place, Moline, IL, 61265-8098, US

(73) Assignee: Deere & Company, a Delaware corporation

(21) Appl. No.: 10/620,657

(22) Filed: Jul. 16, 2003

(51) Int. Cl. A01D 34/14

(52) U.S. Cl. 56/307

(57) ABSTRACT

A hold down clip for a mower comprises a sheet metal frame having first and second legs. The first leg of the hold down clip is provided with a mounting assembly for mounting the hold down clip to a support bar. The second leg of the hold down clip is provided with an enlarged wear plate for directly contacting the reciprocating knives and holding the reciprocating knives against the knife guards. The legs are separated from one another by a distance that is adjustable by an adjustment assembly. The first leg is provided with a transversely extending guide surface for contacting and guiding the reciprocating sickle bar. The raised web portion is provided with a longitudinally extending tang that overlies a rear portion of the reciprocating knives.

### FIELD OF THE INVENTION

The invention is directed to a hold down clip for a reciprocating cutter bar.

### BACKGROUND OF THE INVENTION

Reciprocating cutter bars are used on agricultural harvesting machines to mow a crop to be harvested. These cutter bars typically comprise a transversely extending support bar to which a plurality of knife guards are mounted. The knife guards have a number of longitudinally extending fingers having ledger plates. A reciprocating sickle bar is slidably mounted on the knife guards. The reciprocating sickle bar is provided with a numb er of knives that cooperate with the ledger plates to cut a standing crop with a scissors action. Hold down clips are used to hold the knives in contact with the knife guards.

Hold down clips may be provided with adjustment assemblies that extend between a first mounting leg and a second hold down leg for controlling the hold down force of the hold down leg. An adjustment nut and bolt are used to control the distance between the first and second leg.

### SUMMARY OF THE INVENTION

A hold down clip for a cutter bar of a reciprocating mower comprises a sheet metal frame having first and second legs. The cutter bar to which the hold down clip is mounted comprises a transversely extending support bar, a plurality of knife guards are mounted to the support bar, a transversely extending reciprocating sickle bar is slidably mounted on the knife guards and knives are mounted to the reciprocating sickle bar. The first leg of the hold down clip is provided with a mounting assembly for mounting the hold down clip to the support bar. The second leg of the hold down clip is provided with a hold down assembly for contacting the knives. The hold down assembly comprises an enlarged wear plate that directly contacts the reciprocating knives holding the knives against the knife guards. The legs are separated from one another by a distance. That distance is adjusted by an adjustment assembly.

The first leg is also provided with a transversely extending guide surface for contacting the reciprocating sickle bar. A raised web portion in the first leg is provided with a bolt that extends upwardly through the raised web portion and the second leg. A nut cooperating with the bolt forms the adjustment assembly. The raised web portion is also provided with a longitudinally extending tang that overlies a rear portion of the reciprocating knives.

The hold down assembly of the second leg comprises an enlarged wear plate having a contact surface that is larger than the cross sectional area of the second leg. The second leg is reinforced by two longitudinally extending ribs formed on the sheet metal.

### BRIEF DESCRIPTION OF THE DRAWINGS

FIG. 1 is a cross sectional side view of a cutter bar using the subject hold down clip.

FIG. 2 is a bottom perspective view of the subject hold down clip.

FIG. 3 is a top perspective view of the subject hold down clip.

### DETAILED DESCRIPTION

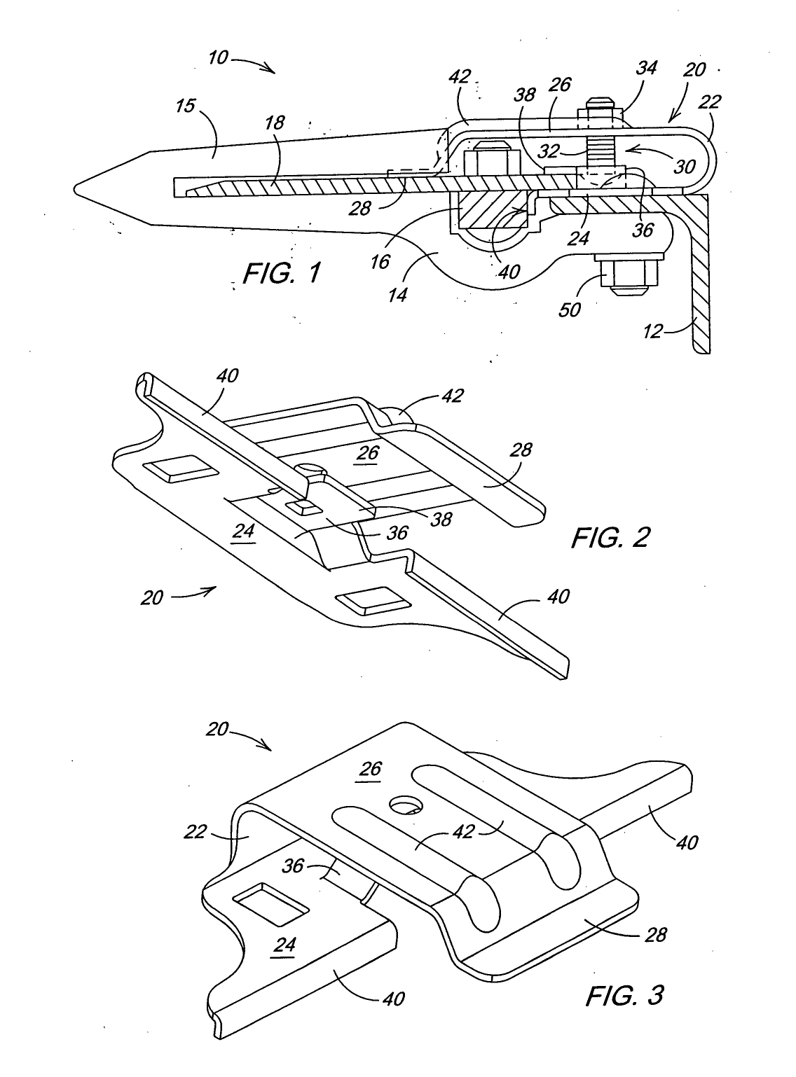

FIG. 1 is a cross sectional side view of a reciprocating cutter bar 10. The stationary parts of the cutter bar 10 comprise a transversely extending stationary support bar 12 to which are mounted a plurality of knife guards 14. Each of the knife guards 14 is provided with a plurality of longitudinally extending fingers 15. The moving portions of the cutter bar comprise a transversely extending reciprocating sickle bar 16 and a plurality of knives 18 that are mounted to reciprocating sickle bar 16. The reciprocating sickle bar 16 is slidably positioned in a channel formed in the knife guards 14. The knifes 18 are bolted to the reciprocating sickle bar 16. The reciprocating movement of the knifes against the ledger plates formed by the longitudinally extended fingers 15, form a scissor action for cutting crop material encountering the cutter bar 10.

To keep the reciprocating sickle bar 16 and associated knives 18 in its correct position regarding the knife guard 14, the cutter bar 10 is provided with a hold down clip 20. The hold down clip 20 comprises a sheet metal frame 22 having a first leg 24 and a second leg 26. The second leg 26 is provided with a hold down assembly formed by wear plate 28 having an enlarged contact surface for directly contacting the reciprocating knives 18. An adjustment assembly 30, is used for adjusting the distance between the first and second legs 24 and 26. The adjustment assembly 30 comprises a bolt 32 extending upwardly from the first leg 24 through the second leg 26, where it is secured thereto by a nut 34. By rotating the nut 34, the distance between the first and second legs 24 and 26 can be adjusted, and thereby the downward force exerted by the wear plate 28 on the reciprocating knifes 18. To accommodate the mounting bolt 32, the first leg is provided with a raised web portion 36 through which the mounting bolt 32 passes. The raised web portion 36 is provided with a longitudinally projecting tang 38, which overlies the rear portion of the reciprocating knives 18. The wear plate 28 and the tang 38 help to maintain the reciprocating knives in their correct vertical position.

The first leg 24 is provided with a guide surface 40, which contacts the rear edge of the reciprocating sickle bar 16. In addition, the second leg 26 is provided with two longitudinally extending reinforcing ribs 42, that are formed out of the sheet metal frame 22.

It should be noted that the mounting bolts 50 used for securing the knife guard 14 to the support bar 12 also secure the hold down clip 20 to the support bar 12.

Having described the illustrated embodiment, it will become apparent that various modifications can be made without departing from the scope of the invention as defined in the accompanying claims.

1. A hold down clip for a cutter bar having a support bar to which a knife guard Is mounted, a reciprocating sickle bar having knives Is slidably mounted on the knife guard, the hold down clip comprising:
an integral frame having a first leg and a second leg that are separated from one another by a distance, the first leg having an offset web portion and forming a mounting assembly for mounting the hold down clip to the support bar and the second leg forming a hold down assembly contacting the knives of the reciprocating sickle bar, the hold down assembly having an enlarged wear plate for contacting and holding the reciprocating sickle bar against the knife guard;
an adjustment assembly extends between the offset web portion of the first leg and second leg for adjusting the distance between the first and second legs.

2. The hold down clip as defined by claim 1 wherein the adjustment assembly comprises a nut and bolt.

3. The hold down clip as defined by claim 2 wherein the bolt extends through the offset web portion across the distance and through the second leg.

4. The hold down clip as defined by claim 3 wherein the knives have a rear portion and the raised web portion has a forwardly projecting tang for receiving the rear portion of the knifes.

5. The hold down clip as defined by claim 4 wherein the first leg Is provided with a guide surface that contacts and guides the reciprocating sickle bar.

6. A hold down clip for a cutter bar having a support bar to which a knife guard is mounted, a reciprocating sickle bar having knives is slidably mounted on the knife guard, the hold down clip comprising:
an integral frame having a first leg and a second leg that are separated from one another by a distance, the first leg having an offset web portion and forming a mounting assembly for mounting the hold down clip to the support bar and the second leg forming a hold down assembly contacting the knives of the reciprocating sickle bar, the first leg is provided with a guide surface that contacts and guides the reciprocating sickle bar;
an adjustment assembly extends between the offset web portion of the first leg and second leg for adjusting the distance between the first and second legs.

7. The hold down clip as defined by claim 6 wherein the hold down assembly having a wear plate for contacting and holding the reciprocating sickle bar against the knife guard.

8. A cutter bar for a mower, the cutter bar comprising:
a transversely extending support bar;
a knife guard is mounted to the support bar having longitudinally extending fingers;
a transversely extending reciprocating sickle bar is slidably mounted on the knife guard;
knives are mounted to the reciprocating sickle bar;
a hold down clip is mounted to the support bar, the hold down clip comprises a sheet metal frame having a first leg having an offset web portion and a longitudinally extending second leg that are separated from one another by a distance, the first leg forming a mounting assembly for mounting the hold down clip to the support bar and the second leg forming a hold down assembly, the hold down assembly having an enlarged wear plate for contacting and holding the reciprocating sickle bar against the knife guard, the second leg is provided with a longitudinally extending reinforcing rib.

9. The cutter bar as defined by claim 8 wherein the first leg is provided with a transversely extending guide surface for contacting and guiding the reciprocating sickle bar.

10. The cutter bar as defined by claim 9 wherein an adjustment assembly extends between the first offset web portion of the first leg and second leg for adjusting the distance between the first and second legs.

11. The cutter bar as defined by claim 10 wherein the adjustment assembly comprises a nut and bolt.

12. The cutter bar as defined by claim 11 wherein the offset web portion for receiving the bolt is located on the first leg, the bolt extending through the raised web portion across the distance and through the second leg.

13. The cutter bar as defined by claim 12 wherein the knives have a rear portion and the raised web portion has a forwardly projecting tang for receiving the rear portion of the knifes.
